(19) United States
(12) Patent Application Publication
(10) Pub. No.: US 2026/0178465 A1
(43) Pub. Date: Jun. 25, 2026

(54) AUTOMATICALLY ENFORCING REVIEW RULES WITHIN A CODE REPOSITORY

(71) Applicant: Capital One Services, LLC, McLean, VA (US)

(72) Inventors: Anthony Hilario BURNS, Wilmington, DE (US); Grant Michael IWAN, Montpelier, VA (US)

(21) Appl. No.: 18/988,071

(22) Filed: Dec. 19, 2024

(51) Int. Cl. G06F 11/3604

(52) U.S. Cl. CPC G06F 11/3608

(57) ABSTRACT

In some implementations, a system for automatically enforcing review rules within a code repository may receive, from a developer device, a pull request for a code branch. The system may perform a first check to determine whether the code branch has at least one review, in the code repository, associated with the code branch. The system may perform a second check to determine whether the at least one review is associated with a non-contributing user for the code branch. The system may perform a third check to determine whether the non-contributing user is associated with a same organization as the code branch. The system may selectively execute the pull request based on results from the first check, the second check, and the third check

### BACKGROUND

Software repositories, such as Github®, store files that include software code for various software projects. Many software projects are developed by a team, where an individual team member may store at least some of those files locally, and the team member may update the code in those locally stored files (e.g., for debugging, to add new features, and so on). The team member may then input a change request to commit the locally stored files to the repository. Some software repositories then automatically generate a pull request based on one or more changes to the software code resulting from the commit.

### SUMMARY

Some implementations described herein relate to a system for automatically enforcing review rules within a code repository. The system may include one or more memories and one or more processors communicatively coupled to the one or more memories. The one or more processors may be configured to receive, from a developer device, a pull request for a code branch. The one or more processors may be configured to perform a first check to determine whether the code branch has at least one review, in the code repository, associated with the code branch. The one or more processors may be configured to perform a second check to determine whether the at least one review is associated with a non-contributing user for the code branch. The one or more processors may be configured to perform a third check to determine whether the non-contributing user is associated with a same organization as the code branch. The one or more processors may be configured to selectively execute the pull request based on results from the first check, the second check, and the third check.

Some implementations described herein relate to a method of using user interfaces (UIs) to enforce a set of review rules within a code repository. The method may include receiving, from a validation system and at a developer device, an indication that a pull request failed the set of review rules. The method may include outputting, in response to the indication that the pull request failed, a first UI indicating that the pull request failed. The method may include receiving, at the developer device, an indication of a first interaction with the first UI. The method may include outputting, in response to the indication of the first interaction, a second UI indicating additional information associated with failure of the pull request.

Some implementations described herein relate to a non-transitory computer-readable medium that stores a set of instructions for automatically enforcing a set of review rules within a code repository. The set of instructions, when executed by one or more processors of a device, may cause the device to receive, from a developer device, a pull request for a code branch. The set of instructions, when executed by one or more processors of the device, may cause the device to validate whether the code branch has at least one review, in the code repository, associated with the code branch. The set of instructions, when executed by one or more processors of the device, may cause the device to verify the at least one review against the set of review rules. The set of instructions, when executed by one or more processors of the device, may cause the device to selectively execute the pull request based on verifying the at least one review against the set of review rules.

### BRIEF DESCRIPTION OF THE DRAWINGS

FIGS. 1A-1E are diagrams of an example associated with automatically enforcing review rules within a code repository, in accordance with some embodiments of the present disclosure.

FIGS. 2A-2D are diagrams of example UIs associated with automatically enforcing review rules within a code repository, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIG. 5 is a flowchart of an example process relating to automatically enforcing review rules within a code repository, in accordance with some embodiments of the present disclosure.

FIG. 6 is a flowchart of an example process relating to outputting UIs based on enforcing review rules within a code repository, in accordance with some embodiments of the present disclosure.

### DETAILED DESCRIPTION

The following detailed description of example implementations refers to the accompanying drawings. The same reference numbers in different drawings may identify the same or similar elements.

In software development, code for an application may include multiple branches. Each branch may have multiple contributors (e.g., developers). A contributor may use a pull request to propose merging a set of changes (e.g., from the contributor) into a code branch. Subsequently, the code branch may be merged into another code branch using a merge request.

Generally, the set of changes should be reviewed before the pull request is approved, in order to reduce errors that would be costly to debug (before production) or to patch (after production). However, contributors may try to bypass reviews and submit pull requests anyway. Alternatively, contributors may try to self-assess or have unauthorized users perform reviews. As a result, the application is more likely to have bugs that consume additional computing resources to correct during a debugging process. Additionally, or alternatively, the application is more likely to have bugs after production that consume additional computing resources in coding and releasing a patch to fix the bugs.

Some implementations described herein enable automatic enforcement of a set of review rules in response to a pull request associated with a code branch. As a result, an application created using the code branch is less likely to have bugs. Having fewer bugs conserves computing resources that otherwise would have been consumed during a debugging process and/or in coding and releasing a patch to correct bugs. Some implementations described herein further provide intuitive UIs that allow developers to quickly resolve issues with review rules. As a result, an application may be compiled and released faster.

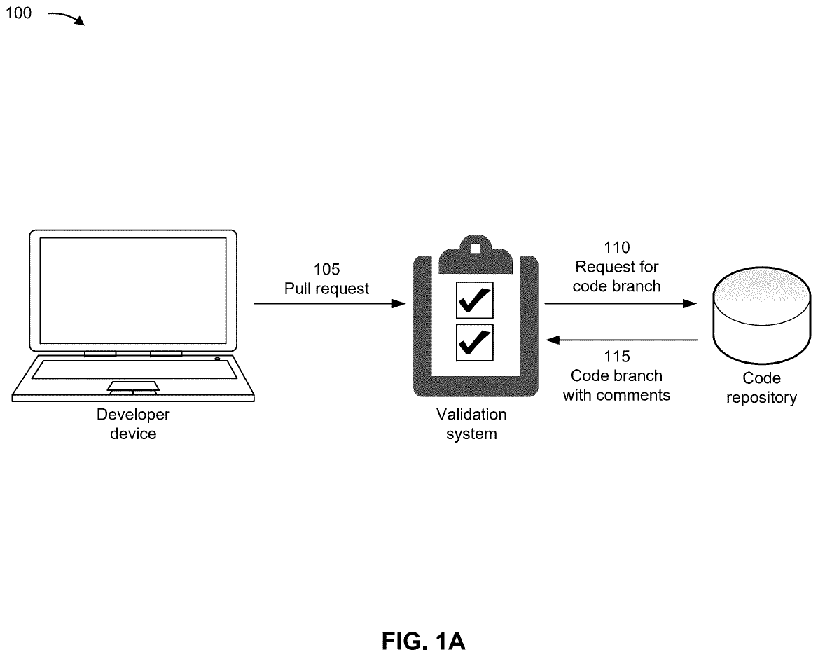

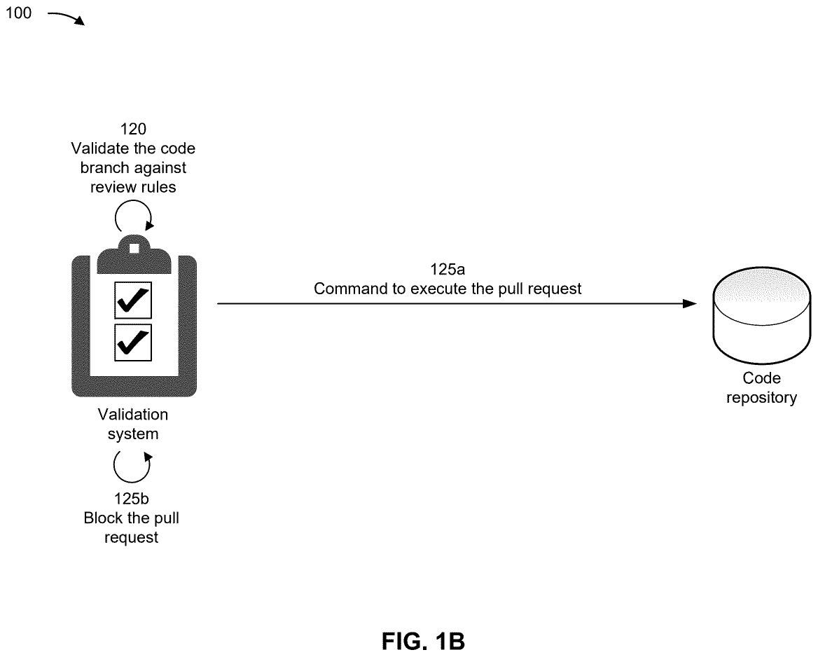

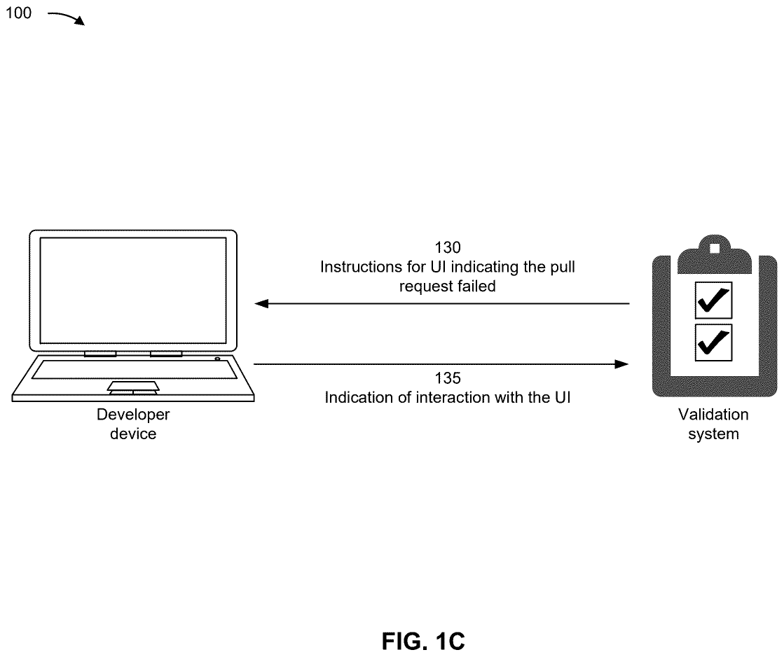

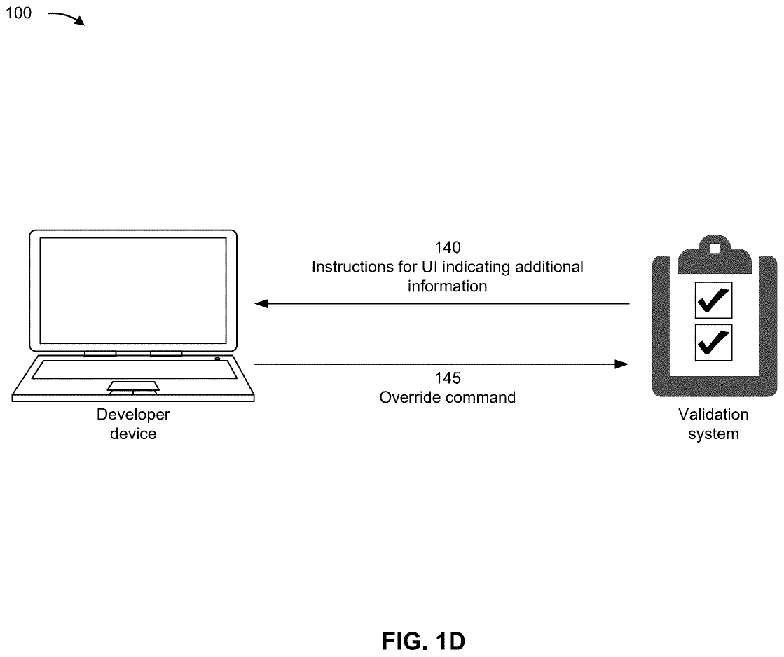

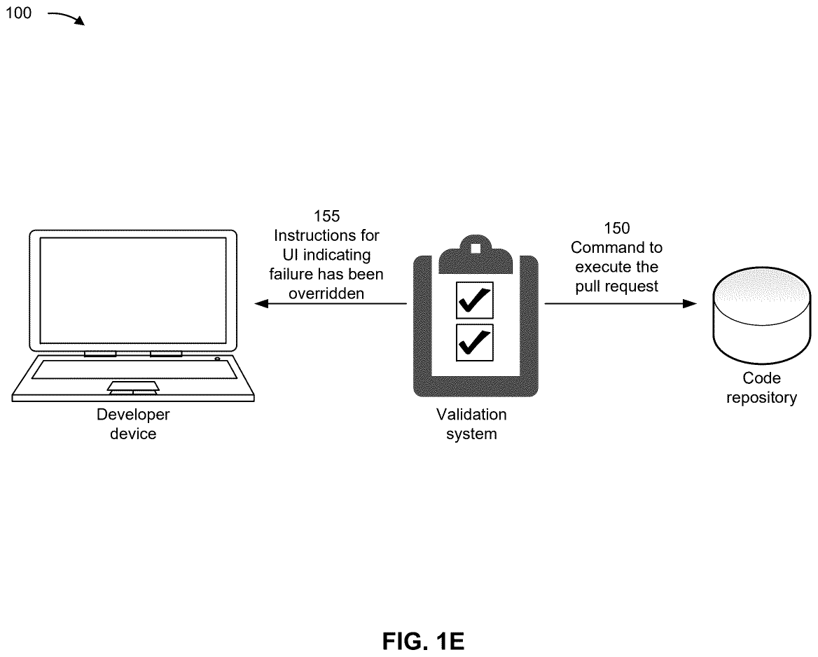

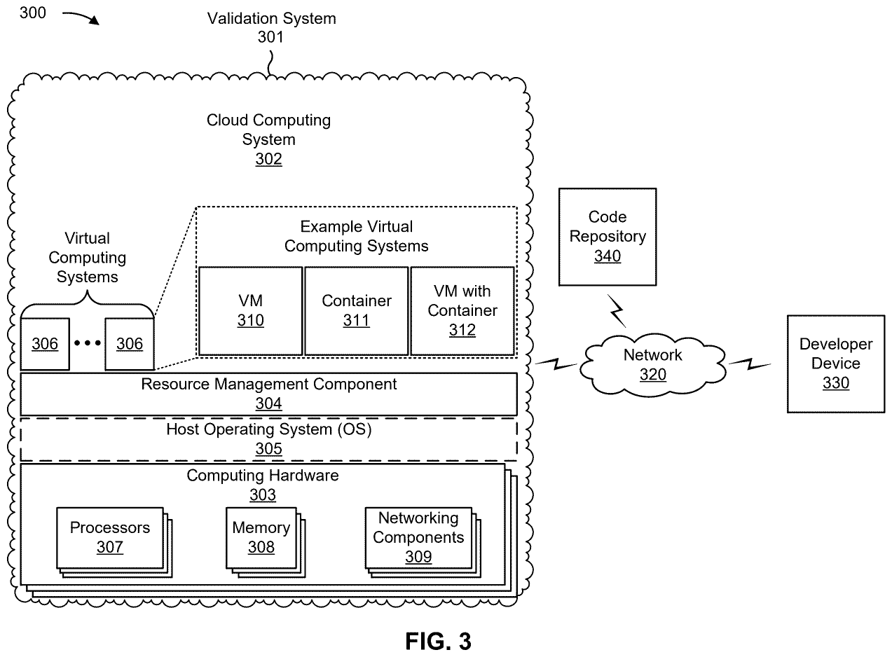

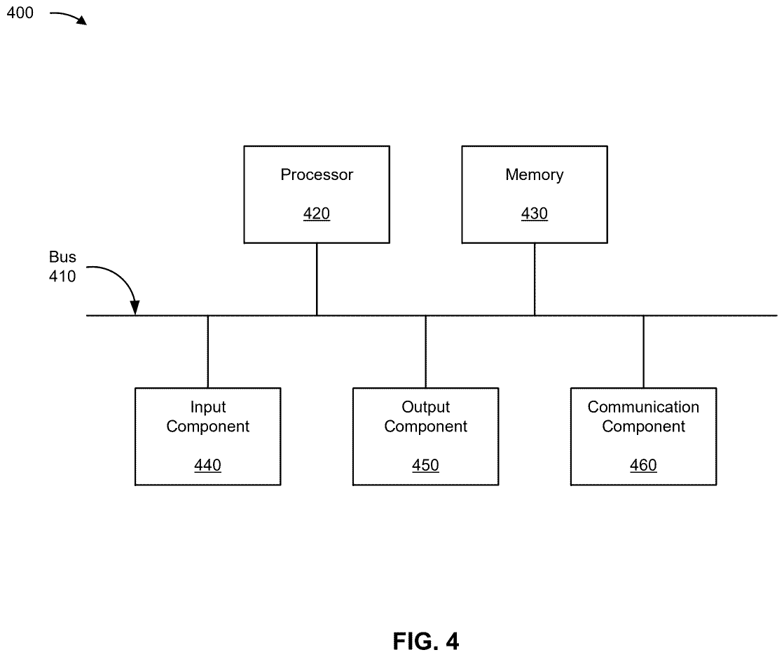

FIGS. 1A-1E are diagrams of an example 100 associated with automatically enforcing review rules within a code repository. As shown in FIGS. 1A-1E, example 100 includes a developer device, a code repository, and a validation system. These devices are described in more detail in connection with FIGS. 3 and 4.

As shown in FIG. 1A and by reference number 105, the developer device may transmit, and the validation system may receive, a pull request for a code branch. The pull request may, in some implementations, be a merge pull request. The pull request may be a hypertext transfer protocol (HTTP) request, a file transfer protocol (FTP) request, and/or an application programming interface (API) call, among other examples.

In one example, a user of the developer device may provide input (e.g., via an input component of the developer device) that triggers the developer device to transmit the pull request. In some implementations, the user may interact with a UI to provide the input. For example, a web browser (or another type of application) executed by the developer device may navigate to a website controlled by (or at least associated with) the validation system. Accordingly, the developer device may output a UI (e.g., via an output component of the developer device) representing the website, and the user may interact with the UI to provide the input. Alternatively, the user may provide text input (e.g., via a command line or a shell, among other examples) to trigger the developer device to transmit the pull request.

In some implementations, the developer device may include a set of credentials with the pull request. The set of credentials may include a username and password, a passkey, a certificate, a signature, a private key, and/or biometric information, among other examples. Therefore, the validation system may validate the set of credentials (e.g., before processing the pull request). In some implementations, the developer device may transmit the set of credentials separately from the pull request. For example, the developer device may transmit the set of credentials initially, and the validation system may accept the pull request from the developer device in response to validating the set of credentials. In another example, the validation system may prompt the developer device in response to the pull request, and the developer device may transmit the set of credentials in response to the prompt. Accordingly, the validation system may validate the set of credentials and may process the pull request in response to validating the set of credentials.

In some implementations, the validation system may receive the pull request using a webhook associated with the code repository. For example, the developer device may transmit the pull request to the code repository, and the code repository may trigger the webhook in response to the pull request. Accordingly, the code repository may request the validation system to perform one or more checks (as described below) before the validation system executes the pull request. Additionally, the code repository may validate a set of credentials from the developer device (e.g., as described above).

Although the example 100 depicts the validation system as separate from the code repository, other examples may include the validation system as (at least partially) integrated (e.g., virtually, logically, and/or physically) with the code repository. Accordingly, the code repository may receive the pull request from the developer device.

As shown by reference number 110, the validation system may transmit, and the code repository may receive, a request for the code branch. For example, the validation system may transmit, and the code repository may receive, the request for the code branch in response to the pull request from the developer device. The request for the code branch may be an HTTP request, an FTP request, and/or an API call. As shown by reference number 115, the code repository may transmit, and the validation system may receive, the code branch (with any comments associated with the code branch). The comments may be included in files of the code branch that also include computer code, and/or in separate files of the code branch. The code repository may transmit, and the validation system may receive, the code branch in response to the request from the validation system.

Although the example 100 is described in connection with the validation system requesting the code branch from the code repository, other examples may include the code repository automatically transmitting the code branch to the validation system. For example, the pull request may trigger the code repository to transmit the code branch to the validation system in addition to triggering the webhook.

As shown in FIG. 1B and by reference number 120, the validation system may validate the code branch against a set of review rules. The set of review rules may include a check to determine whether the code branch has at least one review (in the code repository and associated with the code branch). For example, the validation system may identify whether a comment stored in the code branch indicates that the code branch has at least one review. The comment may be included in a file that also includes computer code, or in a separate file.

Therefore, the validation system may validate whether the code branch has at least one review (in the code repository and associated with the code branch) and may verify the review(s) against the set of (remaining) review rules. The set of (remaining) review rules may include a check to determine whether the at least one review is associated with a non-contributing user for the code branch. For example, the validation system may validate a set of users associated with the at least one review against a list of contributing users associated with the code branch. Additionally, or alternatively, the set of (remaining) review rules may include a check to determine whether a reviewer (e.g., the non-contributing user described above) is associated with a same organization as the code branch. For example, the validation system may receive (e.g., from the code repository, or from a separate database or another separate device or system) registration information associated with the reviewer, and may determine whether the reviewer is associated with the same organization using the registration information.

The validation system may selectively execute (or instruct the code repository to selectively execute) the pull request based on verifying the review(s) against the set of review rules. Therefore, the validation system may execute the pull request in response to the review(s) fulfilling the set of review rules, or may transmit a command to the code repository to execute the pull request, as shown by reference number 125a. On the other hand, the validation system may refrain from executing the pull request in response to the review(s) failing to fulfill the set of review rules, or may otherwise block execution of the pull request, as shown by reference number 125b. In some implementations, the validation system may selectively execute (or instruct the code repository to selectively execute) the pull request based on results from the checks (as described above). For example, the validation system may execute the pull request (or may transmit a command to the code repository to execute the pull request) in response to the code branch passing the checks (e.g., having at least one review, in the code repository, that is associated with a non-contributing user for the code branch, who is associated with a same organization as the code branch).

By automatically enforcing the set of review rules in response to the pull request, the validation system improves an application created using the code branch, because the application is less likely to have bugs. Having fewer bugs conserves computing resources that otherwise would have been consumed during a debugging process and/or in coding and releasing a patch to correct bugs.

When the validation system (and/or the code repository) executes the pull request, the validation system may inform the developer device accordingly. For example, the validation system may output, and the developer device may receive, instructions for a UI indicating that the pull request was executed.

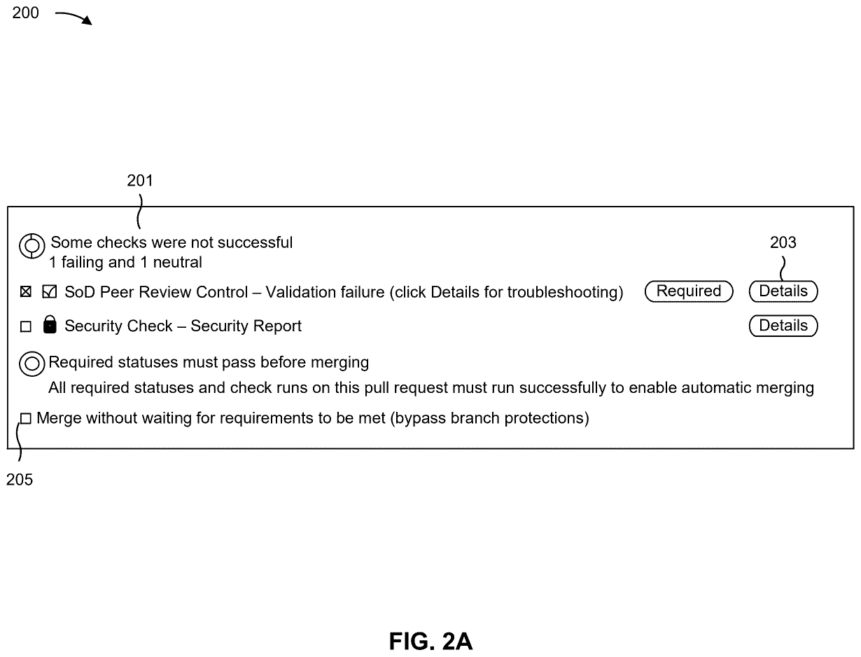

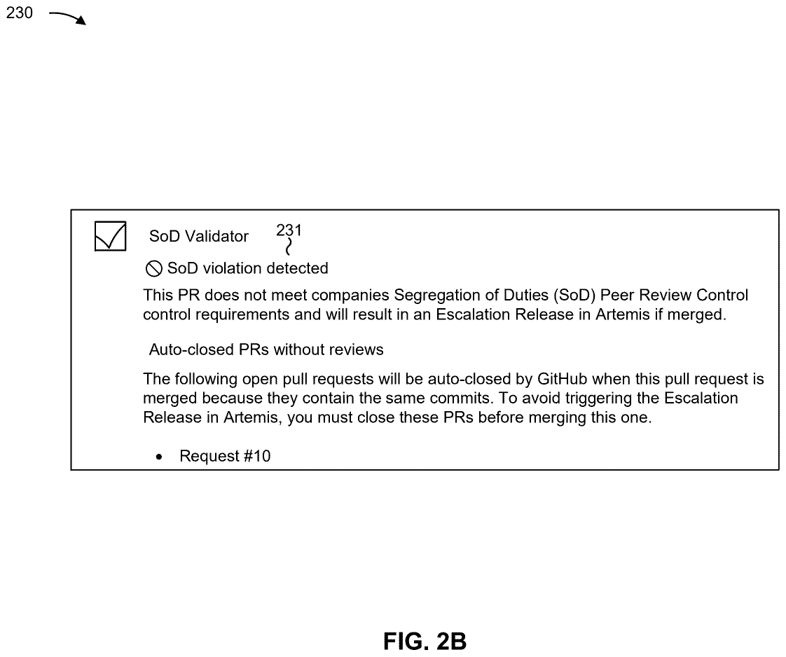

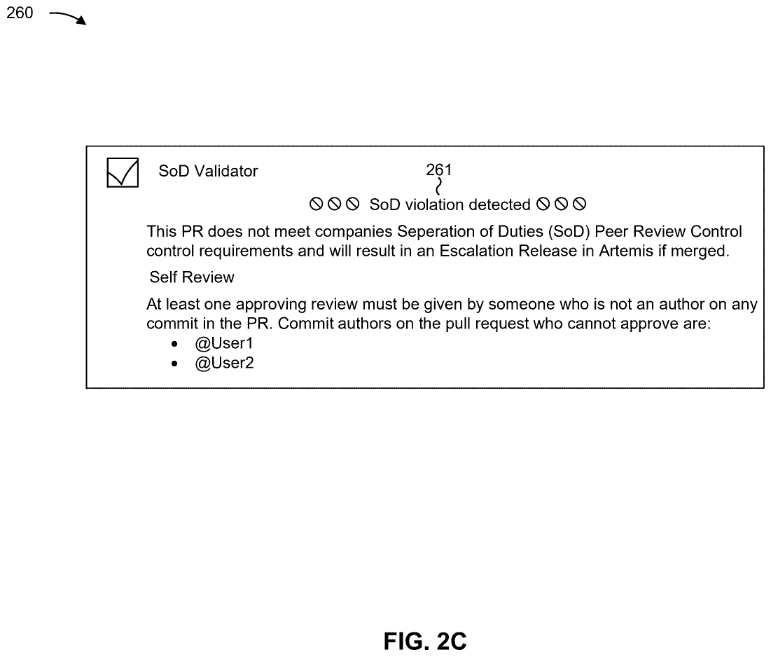

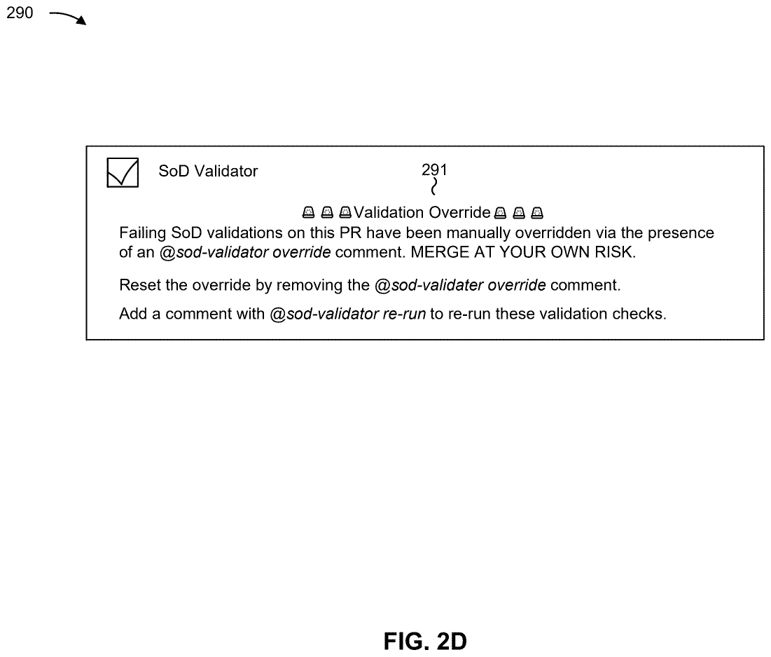

When the validation system (and/or the code repository) refrains from executing the pull request, as shown in FIG. 1C and by reference number 130, the validation system may output, and the developer device may receive, instructions for a UI indicating that the pull request failed. For example, the UI may indicate that the pull request was not executed, as described in connection with FIG. 2A. In some implementations, the validation system may transmit, and the developer device may receive, an indication that the pull request failed, and the developer device may output the UI in response to the indication that the pull request failed.

In some implementations, the UI may further indicate a review rule, in the set of review rules, that was unfulfilled by the code branch, as described in connection with FIGS. 2B and 2C. Alternatively, an indication of the review rule that was unfulfilled may be indicated in a separate UI. For example, as shown by reference number 135, the developer device may transmit, and the validation system may receive, an indication of an interaction (e.g., by the user via an input component of the developer device) with the UI indicating that the pull request failed. Accordingly, in response to the indication of the interaction, as shown in FIG. 1D and by reference number 140, the validation system may output, and the developer device may receive, instructions for a UI indicating additional information associated with failure of the pull request. The additional information may include the indication of the review rule that was unfulfilled, as described in connection with FIGS. 2B and 2C.

By providing easy-to-understand UIs indicating that the review rule that was unfulfilled, the validation system may allow the user to quickly resolve issues and thus satisfy the review rule. As a result, an application created using the code branch may be compiled and released faster.

As shown by in FIG. 1D and by reference number 145, the developer device may transmit, and the validation system may receive, an override command. In some implementations, the developer device may transmit, and the validation system may receive, an indication of an interaction (e.g., by the user via an input component of the developer device) with the UI indicating that the pull request failed, where the indication of the interaction functions as a command to override the failure of the pull request. Additionally, or alternatively, the developer device may upload, and the code repository may receive, a file that instructs an override of the failure of the pull request, where the file functions as a command to override the failure of the pull request.

The validation system may selectively execute the pull request in response to the override command. For example, as shown in FIG. 1E and by reference number 150, the validation system may transmit a command to the code repository to execute the pull request. Additionally, as shown by reference number 155, the validation system may output, and the developer device may receive, instructions for a UI indicating that the failure of the pull request has been overridden (e.g., as described in connection with FIG. 2D).

Although the example 100 is described in connection with the override command being provided after the pull request fails, other examples may include the override command being provided in advance. For example, the validation system may identify the override command in comments stored in the code branch. In another example, the developer device may upload the file that instructs an override of the failure of the pull request prior to transmitting the pull request.

Additionally, or alternatively, although the example 100 is described in connection with the validation system receiving the override command, other examples may include the code repository receiving the override command. Accordingly, the code repository may forward the override command to the validation system. Alternatively, the validation system may indicate results of the checks to the code repository, and the code repository may selectively execute the pull request based on the results; therefore, the code repository may process the override command without involving the validation system.

As indicated above, FIGS. 1A-1E are provided as an example. Other examples may differ from what is described with regard to FIGS. 1A-1E.

FIGS. 2A, 2B, 2C, and 2D are diagrams of example UIs 200, 230, 260, and 290, respectively, associated with automatically enforcing review rules within a code repository. One or more of the example UIs 200, 230, 260, or 290 may be output by a developer device (e.g., using an output component of the developer device) based on instructions from a validation system. These devices are described in more detail in connection with FIGS. 3 and 4.

As shown in FIG. 2A, the example UI 200 may include an indication 201 that a pull request (e.g., from the developer device and associated with a code branch) has failed. For example, the pull request may have failed to pass a set of review rules (e.g., a series of checks, as described in connection with FIG. 1B). The indication 201 includes text and a graphic in FIG. 2A, but may include only text, or only a graphic, in other examples.

As further shown in FIG. 2A, the example UI 200 may include a button 203 (or another type of interactive element). A user (of the developer device) may interact with the button 203 (e.g., by clicking or tapping, among other examples) to trigger the developer device to output a UI with additional information about the pull request (e.g., to output the example UI 230 of FIG. 2B and/or the example UI 260 of FIG. 2C, as described below). Additionally, or alternatively, the example UI 200 may include a button 205 (or another type of interactive element). A user (of the developer device) may interact with the button 205 (e.g., by clicking or tapping, among other examples) to trigger the developer device to transmit an override command (e.g., to the validation system, as described in connection with FIG. 1C).

As shown in FIG. 2B, the example UI 230 may include an indication 231 of which review rule was violated by the pull request (e.g., a “separation of duties” (“SoD”) rule in FIG. 2B, which may require a non-contributing user to review the code branch before the pull request is executed). The indication 231 includes text and a graphic in FIG. 2B, but may include only text, or only a graphic, in other examples.

The example UI 260 of FIG. 2C is similar to the example UI 230 of FIG. 2B. The example UI 260 may include an indication 261 of which review rule was violated by the pull request (e.g., an “SoD” rule in FIG. 2C, which may require a non-contributing user to review the code branch before the pull request is executed). The indication 261 includes text and a graphic in FIG. 2C, but may include only text, or only a graphic, in other examples.

As shown in FIG. 2D, the example UI 290 may include an indication 291 that an override command was provided for the pull request. The indication 291 includes text and a graphic in FIG. 2D, but may include only text, or only a graphic, in other examples.

As indicated above, FIGS. 2A-2D are provided as examples. Other examples may differ from what is described with regard to FIGS. 2A-2D.

FIG. 3 is a diagram of an example environment 300 in which systems and/or methods described herein may be implemented. As shown in FIG. 3, environment 300 may include a validation system 301, which may include one or more elements of and/or may execute within a cloud computing system 302. The cloud computing system 302 may include one or more elements 303-312, as described in more detail below. As further shown in FIG. 3, environment 300 may include a network 320, a developer device 330 and/or a code repository 340. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the validation system 301 may include one or more elements 303-312 of the cloud computing system 302, may execute within the cloud computing system 302, and/or may be hosted within the cloud computing system 302, in some implementations, the validation system 301 may not be cloud-based (e.g., may be implemented outside of a cloud computing system) or may be partially cloud-based. For example, the validation system 301 may include one or more devices that are not part of the cloud computing system 302, such as device 400 of FIG. 4, which may include a standalone server or another type of computing device. The validation system 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The developer device 330 may include one or more devices capable of receiving, generating, storing, processing, and/or providing information associated with pull requests, as described elsewhere herein. The developer device 330 may include a communication device and/or a computing device. For example, the developer device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The developer device 330 may communicate with one or more other devices of environment 300, as described elsewhere herein.

The code repository 340 may include one or more devices capable of receiving, generating, storing, processing, and/or providing information associated with code branches, as described elsewhere herein. For example, the code repository 340 may include Github or SourceForge®, among other examples. The code repository 340 may include a communication device and/or a computing device. For example, the code repository 340 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The code repository 340 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with automatically enforcing review rules within a code repository. The device 400 may correspond to a developer device 330 and/or a code repository 340. In some implementations, a developer device 330 and/or a code repository 340 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

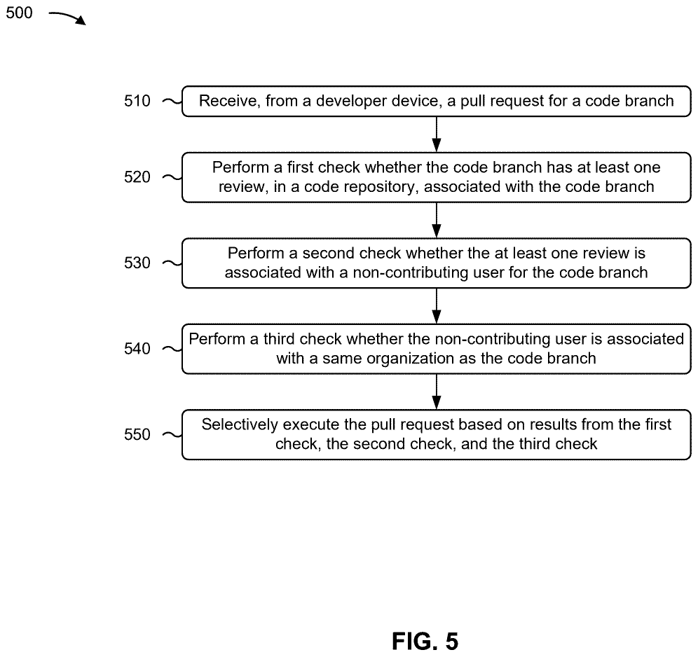

FIG. 5 is a flowchart of an example process 500 associated with automatically enforcing review rules within a code repository. In some implementations, one or more process blocks of FIG. 5 may be performed by a validation system 301. In some implementations, one or more process blocks of FIG. 5 may be performed by another device or a group of devices separate from or including the validation system 301, such as a developer device 330 and/or a code repository 340. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving, from a developer device, a pull request for a code branch (block 510). For example, the validation system 301 (e.g., using processor 420, memory 430, and/or communication component 460) may receive, from a developer device, a pull request for a code branch, as described above in connection with reference number 105 of FIG. 1A. As an example, the validation system 301 may receive the pull request using a webhook associated with the code repository.

As further shown in FIG. 5, process 500 may include performing a first check to determine whether the code branch has at least one review, in the code repository, associated with the code branch (block 520). For example, the validation system 301 (e.g., using processor 420, memory 430, and/or communication component 460) may perform a first check to determine whether the code branch has at least one review, in the code repository, associated with the code branch, as described above in connection with reference number 120 of FIG. 1B. As an example, the validation system 301 may identify whether a comment stored in the code branch indicates that the code branch has at least one review. The comment may be included in a file that also includes computer code or in a separate file.

As further shown in FIG. 5, process 500 may include performing a second check to determine whether the at least one review is associated with a non-contributing user for the code branch (block 530). For example, the validation system 301 (e.g., using processor 420, memory 430, and/or communication component 460) may perform a second check to determine whether the at least one review is associated with a non-contributing user for the code branch, as described above in connection with reference number 120 of FIG. 1B. As an example, the validation system 301 may validate a set of users associated with the at least one review against a list of contributing users associated with the code branch.

As further shown in FIG. 5, process 500 may include performing a third check to determine whether the non-contributing user is associated with a same organization as the code branch (block 540). For example, the validation system 301 (e.g., using processor 420, memory 430, and/or communication component 460) may perform a third check to determine whether the non-contributing user is associated with a same organization as the code branch, as described above in connection with reference number 120 of FIG. 1B. As an example, the validation system 301 may receive registration information associated with the non-contributing user and may determine whether the non-contributing user is associated with the same organization using the registration information.

As further shown in FIG. 5, process 500 may include selectively executing the pull request based on results from the first check, the second check, and the third check (block 550). For example, the validation system 301 (e.g., using processor 420 and/or memory 430) may selectively execute the pull request based on results from the first check, the second check, and the third check, as described above in connection with FIG. 1B. As an example, the validation system 301 may execute the pull request in response to the pull request passing the checks. On the other hand, the validation system 301 may refrain from executing the pull request in response to the pull request failing to pass the checks.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1E and/or FIGS. 2A-2D. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

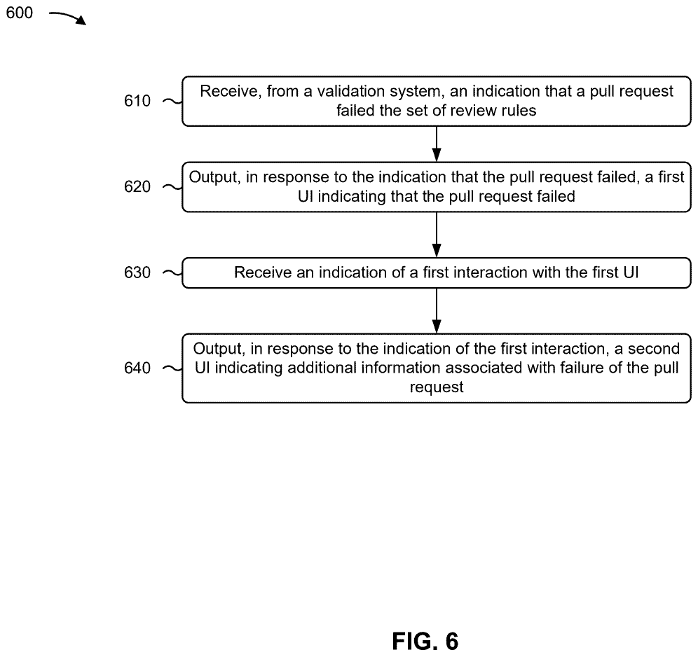

FIG. 6 is a flowchart of an example process 600 associated with outputting UIs based on enforcing review rules within a code repository. In some implementations, one or more process blocks of FIG. 6 may be performed by a developer device 330. In some implementations, one or more process blocks of FIG. 6 may be performed by another device or a group of devices separate from or including the developer device 330, such as a validation system 301 and/or a code repository 340. Additionally, or alternatively, one or more process blocks of FIG. 6 may be performed by one or more components of the device 400, such as processor 420, memory 430, input component 440, output component 450, and/or communication component 460.

As shown in FIG. 6, process 600 may include receiving, from a validation system, an indication that a pull request failed the set of review rules (block 610). For example, the developer device 330 (e.g., using processor 420, memory 430, and/or communication component 460) may receive, from a validation system, an indication that a pull request failed the set of review rules, as described above in connection with FIG. 1C. As an example, the developer device 330 may receive the indication in response to transmitting the pull request to the validation system (or to a code repository).

As further shown in FIG. 6, process 600 may include outputting, in response to the indication that the pull request failed, a first UI indicating that the pull request failed (block 620). For example, the developer device 330 (e.g., using processor 420, memory 430, and/or output component 450) may output, in response to the indication that the pull request failed, a first UI indicating that the pull request failed, as described above in connection with FIG. 1C. As an example, the first UI may be as described in connection with FIG. 2A.

As further shown in FIG. 6, process 600 may include receiving an indication of a first interaction with the first UI (block 630). For example, the developer device 330 (e.g., using processor 420, memory 430, and/or input component 440) may receive an indication of a first interaction with the first UI, as described above in connection with FIG. 1C. As an example, the first interaction may include a click associated with a button, as described in connection with FIG. 2A.

As further shown in FIG. 6, process 600 may include outputting, in response to the indication of the first interaction, a second UI indicating additional information associated with failure of the pull request (block 640). For example, the developer device 330 (e.g., using processor 420, memory 430, and/or output component 450) may output, in response to the indication of the first interaction, a second UI indicating additional information associated with failure of the pull request, as described above in connection with FIG. 1D. As an example, the additional information may include an indication of a review rule that was unfulfilled, as described in connection with FIGS. 2B and 2C.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1E and/or FIGS. 2A-2D. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for automatically enforcing review rules within a code repository, the system comprising:
one or more memories; and
one or more processors, communicatively coupled to the one or more memories, configured to:
receive, from a developer device, a pull request for a code branch;
perform a first check to determine whether the code branch has at least one review, in the code repository, associated with the code branch;
perform a second check to determine whether the at least one review is associated with a non-contributing user for the code branch;
perform a third check to determine whether the non-contributing user is associated with a same organization as the code branch; and
selectively execute the pull request based on results from the first check, the second check, and the third check.

2. The system of claim 1, wherein the pull request comprises a merge pull request.

3. The system of claim 1, wherein the one or more processors, to receive the pull request, are configured to:
receive the pull request using a webhook associated with the code repository.

4. The system of claim 1, wherein, to perform the first check, the one or more processors are configured to:
identify whether a comment stored in the code branch indicates that the code branch has at least one review.

5. The system of claim 1, wherein, to perform the second check, the one or more processors are configured to:
validate a set of users associated with the at least one review against a list of contributing users associated with the code branch.

6. The system of claim 1, wherein, to perform the third check, the one or more processors are configured to:
receive registration information associated with the non-contributing user; and
determine whether the non-contributing user is associated with a same organization using the registration information.

7. The system of claim 1, wherein the one or more processors are configured to:
identify an override command in comments stored in the code branch,
wherein the pull request is selectively executed in response to the override command.

8. A method of using user interfaces (UIs) to enforce a set of review rules within a code repository, comprising:
receiving, from a validation system and at a developer device, an indication that a pull request failed the set of review rules;
outputting, in response to the indication that the pull request failed, a first UI indicating that the pull request failed;
receiving, at the developer device, an indication of a first interaction with the first UI; and
outputting, in response to the indication of the first interaction, a second UI indicating additional information associated with failure of the pull request.

9. The method of claim 8, further comprising:
outputting a third UI indicating that the failure of the pull request has been overridden.

10. The method of claim 9, further comprising:
receiving, at the developer device, an indication of a second interaction with the first UI,
wherein the third UI is output in response to the indication of the second interaction.

11. The method of claim 10, further comprising:
transmitting, to the validation system, a command to override the failure of the pull request in response to the indication of the second interaction.

12. The method of claim 8, further comprising:
uploading, to the code repository, a file that instructs an override of the failure of the pull request,
wherein the second UI further indicates that the failure of the pull request has been overridden.

13. The method of claim 8, further comprising:
transmitting, to the validation system, the pull request.

14. A non-transitory computer-readable medium storing a set of instructions for automatically enforcing a set of review rules within a code repository, the set of instructions comprising:
one or more instructions that, when executed by one or more processors of a device, cause the device to:
receive, from a developer device, a pull request for a code branch;
validate whether the code branch has at least one review, in the code repository, associated with the code branch;
verify the at least one review against the set of review rules; and
selectively execute the pull request based on verifying the at least one review against the set of review rules.

15. The non-transitory computer-readable medium of claim 14, wherein the one or more instructions, when executed by the one or more processors, cause the device to:
receive, from the developer device, a set of credentials,
wherein the pull request is received based on validating the set of credentials.

16. The non-transitory computer-readable medium of claim 14, wherein the one or more instructions, that cause the device to selectively execute the pull request, cause the device to: execute the pull request in response to the at least one review fulfilling the set of review rules.

17. The non-transitory computer-readable medium of claim 14, wherein the one or more instructions, that cause the device to selectively executive the pull request, cause the device to:
refrain from executing the pull request in response to the at least one review failing to fulfill the set of review rules.

18. The non-transitory computer-readable medium of claim 14, wherein the one or more instructions, when executed by the one or more processors, cause the device to:
output instructions for a user interface indicating that the pull request was executed.

19. The non-transitory computer-readable medium of claim 14, wherein the one or more instructions, when executed by the one or more processors, cause the device to:
output instructions for a user interface indicating that the pull request was not executed.

20. The non-transitory computer-readable medium of claim 14, wherein the one or more instructions, when executed by the one or more processors, cause the device to:
output instructions for a user interface indicating a review rule, in the set of review rules, that was unfulfilled by the code branch.
